(19) United States
(12) Patent Application Publication
(10) Pub. No.: US 2009/0086642 A1
(43) Pub. Date: Apr. 2, 2009

(54) High availability path audit

(75) Inventors: Gary Martin Davis, Los Gatos, CA (US); Kenneth W. Jett, Alpharetta, GA (US)

Correspondence Address: Weaver Austin Villeneuve & Sampson LLP, P.O. BOX 70250, OAKLAND, CA, 94612-0250, US

(73) Assignee: Cisco Technology, Inc.

(21) Appl. No.: 11/904,822

(22) Filed: Sep. 28, 2007

(51) Int. Cl. G01R 31/08; G06F 11/00

(52) U.S. Cl. 370/242; 370/248

(57) ABSTRACT

In one embodiment, an apparatus identifies two or more network devices in a path between a first endpoint and a second endpoint. The apparatus obtains a measurement of one or more metrics pertaining to functionality of the two or more network devices in the path between the first endpoint and the second endpoint. The apparatus may process the one or more metrics pertaining to the functionality of the two or more network devices to generate a report pertaining to the path between the first endpoint and the second endpoint.

### BACKGROUND

1. Technical Field

The present disclosure relates generally to assessing the functionality of one or more network devices.

2. Description of the Related Art

Service providers often provide Service Level Agreements (SLA) to their customers. These SLAs typically guarantee a level of service to the customers in accordance with the details provided in the SLAs. However, it is difficult to measure the factors that can affect the level of service that is provided to each customer. In addition, it is difficult to measure the factors that may further affect the level of service provided to end users of the customer's network.

### BRIEF DESCRIPTION OF THE DRAWINGS

FIG. 1 is an example system in which various embodiments may be implemented.

FIG. 2 is a process flow diagram illustrating an example method of measuring availability of a network device.

FIG. 3 is a process flow diagram illustrating an example method of measuring availability of a path through a network.

FIG. 4 is a diagram illustrating an example of intelligence that may be implemented by a process such as that described with reference to FIG. 3.

FIG. 5 is an example report that may be generated using a process such as that described with reference to FIG. 3.

FIG. 6 is a diagrammatic representation of an example router in which various embodiments may be implemented.

### DESCRIPTION OF EXAMPLE EMBODIMENTS

In the following description, numerous specific details are set forth in order to provide a thorough understanding of the disclosed embodiments. It will be obvious, however, to one skilled in the art, that the disclosed embodiments may be practiced without some or all of these specific details. In other instances, well known process steps have not been described in detail in order not to unnecessarily obscure the disclosed embodiments.

Overview

In one embodiment, an apparatus identifies two or more network devices in a path between a first endpoint and a second endpoint. The apparatus obtains a measurement of one or more metrics pertaining to functionality of the two or more network devices in the path between the first endpoint and the second endpoint. The apparatus may process the one or more metrics pertaining to the functionality of the two or more network devices to generate a report pertaining to the path between the first endpoint and the second endpoint.

### SPECIFIC EXAMPLE EMBODIMENTS

In accordance with various embodiments of the invention, a network device may assess its own functionality. Such an assessment may be provided in a variety of forms including, but not limited to, one or more metrics and/or recommendations. Using the assessment provided by each network device in a particular path in a network, the “availability” of the path may be assessed.

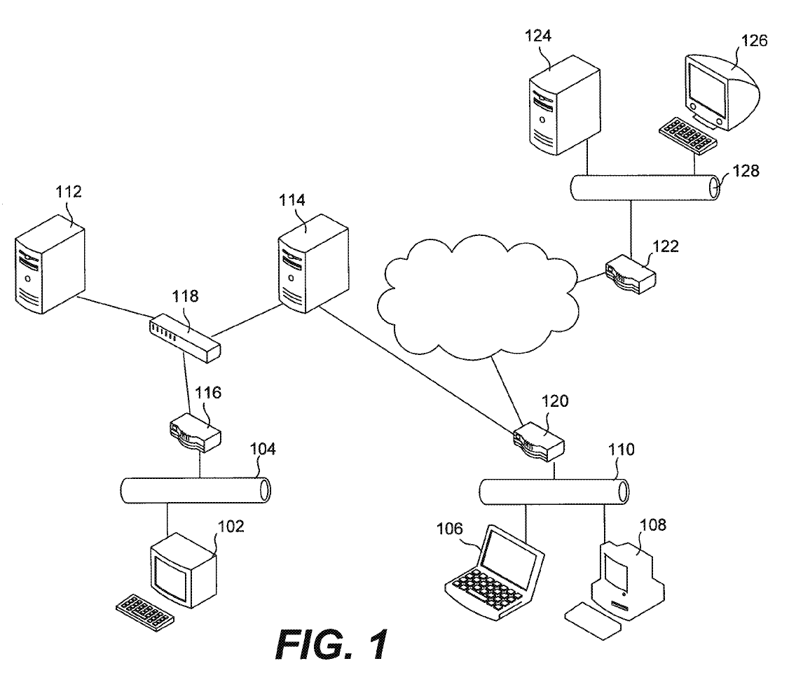

FIG. 1 is an example system in which various embodiments may be implemented. As shown in FIG. 1, a network such as a customer network (e.g., private network) may include a variety of client network devices available to end-users of the network. For instance, in this example, a first client device 102 is coupled to a first network segment 104. A second client device 106 and a third client device 108 are coupled to a second network segment 110. Any of the client devices 102, 106, 108 may access services provided by one or more network devices, such as servers 112 and 114.

A path between any two network devices may be defined. More particularly, a path between a first endpoint and a second endpoint may be defined. The first endpoint may be a client network device, while the second endpoint may be a network device providing one or more services. The path between two endpoints may include one or more network devices. For example, these network devices may include, but are not limited to, routers, bridges, and switches.

For example, a first path may be defined between the first client device 102 and the server 112. The network devices in the first path between the first client device 102 and the server 112 include network device 116 and network device 118. In this example, the network device 116 and the network device 118 are shown to be a router and a switch, respectively.

As another example, a second path may be defined between the third client device 108 and the server 114. The network devices in the second path between the third client device 108 and the server 114 include router 120. Thus, a path between two endpoints may include one or more network devices.

The customer network may be coupled to another network such as a service provider network via a network device in the service provider network such as router 122, as well as a network device in the customer network, such as the router 120. As shown in this example, network devices such as server 124 and computer 126 may be coupled to network segment 128 of the service provider network. While service providers may measure the roundtrip time between a service provider device and a customer device, service providers have limited means for ensuring that their SLAs are satisfied. Moreover, private networks such as the customer network shown in FIG. 1 generally do not perform measurements of the “availability” of the private network.

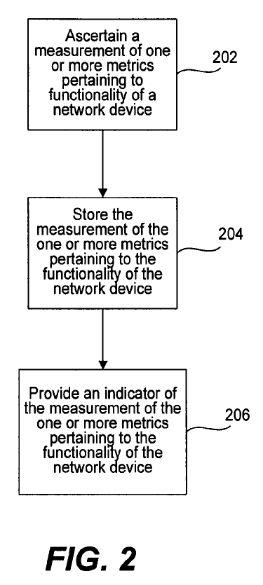

In order to measure the availability of the network, one or more network devices in the network may each be configured to assess its own functionality. FIG. 2 is a process flow diagram illustrating an example method of measuring availability of a network device. As shown at 202, a network device may ascertain a measurement of one or more metrics pertaining to functionality of the network device. For instance, the metrics may include recovery time due to failure of hardware of the network device and/or recovery time due to failure of software running on the network device.

The network device may store the measurement of the one or more metrics pertaining to the functionality of the network device at 204. For instance, the network device may build up and maintain a knowledge-base to track measurements associated with the network device over time. The network device may also provide an indicator of the measurement of the one or more metrics pertaining to the functionality of the network device at 206. More particularly, the network device may provide a report regarding its own functionality. For example, the network device may analyze the measurement of the metric(s) pertaining to the functionality of the network device in order to provide one or more recommendations pertaining to the network device. For instance, these recommendations may include recommended configurations of one or more operating parameters of the network device. These operating parameters may include, but are not limited to, Quality of Service and amount of packet compression associated with packets to be transmitted. Moreover, the network device may provide such an indicator, which may include metrics or analysis of the metrics, to another network device that compiles information received from a plurality of network devices.

Once data has been received from one or more network devices in a particular path in a network, the data may be used to assess the availability of the path. While a particular path between two endpoints may include a single network device, such a path will generally include two or more network devices. Thus, in order to simplify the description below, it is assumed that a path between two endpoints includes two or more network devices.

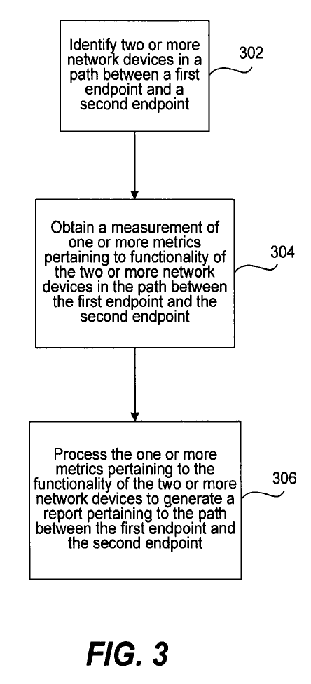

FIG. 3 is a process flow diagram illustrating an example method of measuring availability of a path through a network. In order to measure the availability of a path through a network, a network device (i.e., path data collector) may identify two or more network devices (i.e., path data providers) in a path between a first endpoint and a second endpoint 302. For example, a user such as an engineer or customer may define a path through the network by configuring two endpoints and/or those network devices between those endpoints (e.g., using an application). In this manner, the path data collector may identify the path data providers in the path between the first endpoint and the second endpoint. Thus, the path data providers in the path may include (or exclude) either or both endpoints. The endpoints may be in the same network. For instance, the endpoints may be in a customer network (e.g., private network), rather than a service provider network. More particularly, the first endpoint may correspond to a host/end-user and the second endpoint may correspond to a server or other system.

The path data collector may obtain a measurement of one or more metrics pertaining to functionality of the path data providers in the path between the first endpoint and the second endpoint at 304. For instance, the measurement of the one or more metrics may be received from (e.g., transmitted by) the path data providers.

The path data collector may store the measurement(s) it has received from the path data providers. For instance, the path data collector may store these measurements in a central database in association with the identified path. The path data collector may also build up and maintain a knowledge-base for specific network devices and/or models. For instance, the knowledge-base may include data for specific router models (e.g., Cisco 7500), where the data associated with each model has been compiled using data received from one or more network devices of that model. In this manner, the data for each type of network device (e.g., router, switch, etc.) and/or model may be compiled using data received from one or more network devices. The data path collector may also maintain measurements in association with a plurality of paths.

In addition, the path data collector may process (e.g., consolidate or analyze) the measurements of the metrics pertaining to the functionality of the two or more path data providers to generate a report pertaining to the path between the first endpoint and the second endpoint 306. The report may include a broad summary or indication of the results of analysis of the metrics pertaining to the path between the two endpoints. For example, the report may include one or more recommendations with respect to configurations of one or more of the path data providers, as set forth above. These recommendations may include, for example, optimum configurations of one or more of the path data providers in the path. For example, a recommendation may indicate whether a particular feature of a network device should be turned on or off. These recommendations may also incorporate any additional knowledge that has been obtained from the knowledge-base. For instance, prior data that has been received or compiled for the same type of network device(s) and/or the same model(s) may be incorporated or weighted. In this manner, the report may indicate features of the network devices that can be leveraged, or areas of concern. Moreover, the data path collector may process the measurements pertaining to two or more paths, enabling an optimal path to be identified.

As set forth above, the network devices in a particular path may include one or both endpoints. As a result, recommendations may be pertinent to one or both of the endpoints. In fact, there are a number of instances where the performance of a path may be negatively affected by an endpoint (e.g., client or server). For example, an Ethernet duplex setting on an endpoint on which a 100 Mbps link is configured for half duplex may result in poor performance. However, changes may be made to both ends of the link (e.g. network device and client/server) in order to realize proper performance. Accordingly, the performance of one or both endpoints may result in recommended changes to one or both endpoints, as well as a network device connecting to a problematic endpoint.

Moreover, the report may indicate measurements of one or more metrics pertaining to the path. For instance, such measurements may include the total hardware recovery time and/or total software recovery time pertinent to the path, thereby providing an assessment of the availability of the path. These measurements may incorporate any additional knowledge that has been obtained from the knowledge-base. For instance, prior data that has been received or compiled for the same type of network device(s) and/or the same model(s) may be incorporated or weighted.

The network device that generates the report may be one of the network devices in the path (e.g., one of the endpoints). Alternatively, the network device may be outside the defined path.

As set forth above with respect to FIGS. 2 and 3, the functionality of a network device or a path including two or more network devices may be assessed using measurements of one or more metrics. The metrics for which measurements may be obtained may include one or more metrics measuring recovery time due to failure of hardware of a network device. Such a metric may be obtained for each network device in a particular path. The recovery time may be the time from failure of the hardware of a network device to the time that the network device including the hardware is functioning (e.g., due to backup hardware or otherwise). As one example, it may be desirable to measure the recovery time from a failure of hardware (e.g., processor) to the time it takes to failover to redundant hardware (e.g., a redundant processor). Moreover, hardware of a network device may include one or more line cards. Thus, a different measurement may be associated with the recovery time due to the failure of each of the line cards of a particular network device.

Another metric pertaining to the functionality of a single network device or two or more network devices in a particular path may include a measurement of time between a first failure of the hardware of one of the network devices and a second failure of the hardware of the same network device. More particularly, the measurement may indicate the time between two sequential failures of the same hardware (e.g., line card or interface). For example, it may be desirable to assess each incoming and outgoing interface. Such a measurement may be referred to in the form of a Mean Time Between Failures (MTBF).

Moreover, in the event of a failure of an interface, it may be desirable to route traffic via another interface or network device. As a result, it may be desirable to measure the recovery time from a failure of an interface to the time it takes for traffic to be routed to another interface or network device. For instance, the Routing Information Protocol (RIP) may have a recovery time of 30 seconds, while a link state protocol such as Open Shortest Path First (OSPF) Protocol may have a recovery time of 1 second.

In addition, one or more metrics pertaining to the functionality of a network device, or two or more network devices in a particular path, may include a measurement of recovery time due to failure of a software application running on the two or more network devices. For example, the software application may be pertinent to an operating system or a routing protocol. Moreover, where dual software processes are running on a network device, the recovery time may be the time from failure of a first software process to the failover to another second software process.

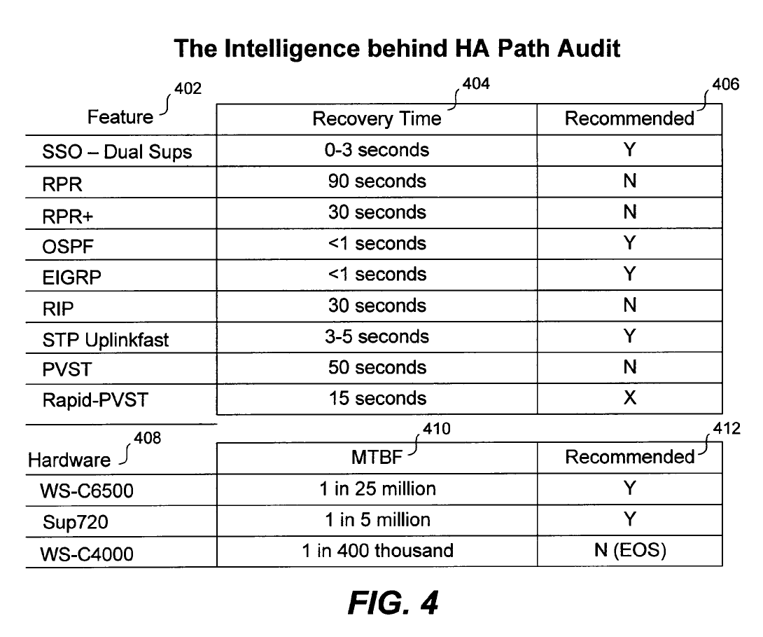

FIG. 4 is a diagram illustrating an example of intelligence that may be implemented by a process such as that described with reference to FIG. 3. The intelligence may be statically configured, or may be compiled over time as data is collected. As shown in this example, various features (e.g., software applications) 402 may each have an associated recovery time 404 or range of possible recovery times. Each of the features 402 may also have an associated recommendation 406, indicating whether the feature is recommended. As shown, a “Y” indicates that the feature is recommended, while a “N” indicates that the feature is not recommended. For example, a feature having a recovery time of less than or equal to 10 seconds may be recommended, while a feature having a recovery time of greater than 10 seconds may not be recommended.

Examples of software features for which data may be obtained or that may be analyzed (e.g., for possible recommendation) include Stateful Switchover (SSO) in association with the use of dual supervisors, Route Processor Redundancy (RPR), RPR+, OSPF, Enhanced Interior Gateway Routing Protocol (EIGRP), RIP, Spanning Tree Protocol (STP) Uplinkfast, Per VLAN Spanning Tree (PVST), Rapid-PVST.

Similarly, various hardware devices (or hardware components in a hardware device) 408 may have an associated Mean Time Between Failures (MTBF) 410. Those hardware devices 408 having an acceptable MTBF 410 (e.g., less than or equal to 1 in 3 million) may be recommended. As set forth above, a hardware device that is recommended may be specified by a “Y.”

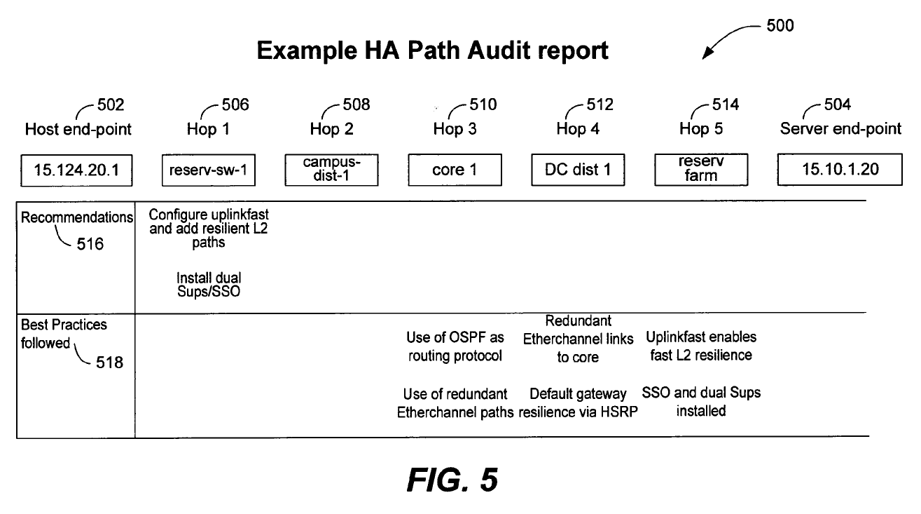

FIG. 5 is an example report 500 that may be generated using a process such as that described with reference to FIG. 3. The report 500 may identify each endpoint. In this example, the report 500 identifies a host endpoint 502 and a server endpoint 504, which may each be identified by an IP address. In addition, multiple network devices 506, 508, 510, 512, 514 in the path between the endpoints 502, 504 may also be identified by an IP address or other suitable label, such as “Hop 1” or “reserve-sw-1.”

The report 500 may provide one or more recommendations 516 in association with one or more of the network devices 506, 508, 510, 512, 514, as shown. In addition, although not shown in this example, one or more recommendations 516 may also be provided in association with one or both of the endpoints 502, 504. In this example, the recommendations 516 in association with Hop 1 506 indicate that the uplinkfast feature should be configured, and resilient Layer 2 (L2) paths should be added. In addition, the recommendations 516 in association with Hop 1 506 further indicate that SSO and dual supervisors should be installed. Similarly, in association with Hop 2 508, the recommendations 516 indicate that due to a low MTBF, the aging switch should be replaced.

Similarly, the report 500 may also indicate one or more best practices followed 518. Best practices followed 518 may include best known practices that are currently being implemented. In other words, the best practices followed 518 may include configurations or hardware that should not be modified. In this example, the best practices followed 518 include the use of OSPF as a routing protocol and the use of redundant Etherchannel paths in association with Hop 3 510. In addition, the best practices followed 518 with respect to Hop 4 512 include redundant Etherchannel links to the core, in addition to default gateway resilience via Hot Standby Router Protocol (HSRP). The best practices followed 518 with respect to Hop 5 514 include the use of the uplink fast feature, which enables fast L2 resilience, as well as the installation of SSO and dual Supervisors.

Although not shown, the report 500 may also provide information associated with multiple paths. For example, the report 500 may identify an optimal path to be used.

Generally, the techniques for performing the disclosed embodiments may be implemented on software and/or hardware. For example, they can be implemented in an operating system kernel, in a separate user process, in a library package bound into network applications, on a specially constructed machine, or on a network interface card. In a specific embodiment of this invention, the techniques of the present invention are implemented in software such as an operating system or in an application running on an operating system.

A software or software/hardware hybrid packet processing system of this invention may be implemented on a general-purpose programmable machine selectively activated or reconfigured by a computer program stored in memory. Such programmable machine may be a network device designed to handle network traffic. Such network devices typically have multiple network interfaces including frame relay and ISDN interfaces, for example. Specific examples of such network devices include routers and switches. For example, the packet processing systems of this invention may be specially configured routers such as specially configured router models 1600, 2500, 2600, 3600, 4500, 4700, 7200, 7500, and 12000 available from Cisco Systems, Inc. of San Jose, Calif. A general architecture for some of these machines will appear from the description given below. Further, the invention may be at least partially implemented on a card (e.g., an interface card) for a network device or a general-purpose computing device.

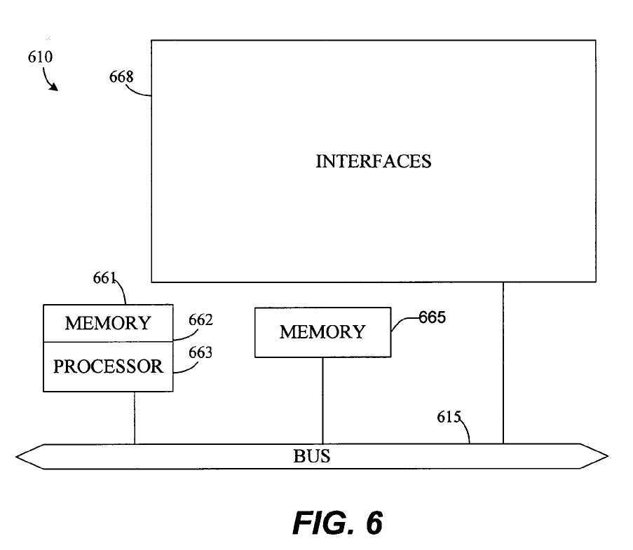

In one embodiment, the network device implementing the disclosed embodiments is a router. The router may include one or more line cards. Referring now to FIG. 6, a router 610 suitable for implementing embodiments of the invention includes a master central processing unit (CPU) 662, interfaces 668, and a bus 615 (e.g., a PCI bus). When acting under the control of appropriate software or firmware, the CPU 662 is responsible for such router tasks as routing table computations and network management. It may also be responsible for implementing the disclosed embodiments, in whole or in part. The router may accomplish these functions under the control of software including an operating system (e.g., the Internetwork Operating System (IOS®) of Cisco Systems, Inc.) and any appropriate applications software. CPU 62 may include one or more processors 663 such as a processor from the Motorola family of microprocessors or the MIPS family of microprocessors. In an alternative embodiment, processor 663 is specially designed hardware for controlling the operations of router 10. In a specific embodiment, a memory 661 (such as non-volatile RAM and/or ROM) also forms part of CPU 662. However, there are many different ways in which memory could be coupled to the system. Memory block 661 may be used for a variety of purposes such as, for example, caching and/or storing data, programming instructions, etc.

The interfaces 668 are typically provided as interface cards (sometimes referred to as “line cards”). Generally, they control the sending and receiving of data packets or data segments over the network and sometimes support other peripherals used with the router 610. Among the interfaces that may be provided are Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces, LAN interfaces, WAN interfaces, metropolitan area network (MAN) interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 662 to efficiently perform routing computations, network diagnostics, security functions, etc. Of course, one or more external processors may also be implemented to perform various metric collection and reporting functionality. Although the system shown in FIG. 6 is one specific router of the present invention, it is by no means the only router architecture on which the disclosed embodiments can be implemented. For example, an architecture having a single processor that handles communications as well as routing computations, etc. is often used. Further, other types of interfaces and media could also be used with the router.

Regardless of network device's configuration, it may employ one or more memories or memory modules (such as, for example, memory block 665) configured to store data, program instructions for the general-purpose network operations and/or the inventive techniques described herein. The program instructions may control the operation of an operating system and/or one or more applications, for example.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks, floppy disks, and magnetic tape; optical media such as CD-ROM disks and DVDs; magneto-optical media such as floptical disks; and hardware devices that are specially configured to store and perform program instructions, such as read-only memory devices (ROM) and random access memory (RAM). The disclosed embodiments may also be embodied in a carrier wave traveling over an appropriate medium such as optical lines, electric lines, etc. Examples of program instructions include both machine code, such as produced by a compiler, and files containing higher level code that may be executed by the computer using an interpreter.

Although illustrative embodiments and applications of the disclosed embodiments are shown and described herein, many variations and modifications are possible which remain within the concept, scope, and spirit of the embodiments of the invention, and these variations would become clear to those of ordinary skill in the art after perusal of this application. For instance, measurements may include recovery times or other numerical data related to various features, such as Quality of Service (QoS) congestion management. As one example, recommendations may indicate optimum settings for traffic compression, packet dropping, etc. Moreover, the disclosed embodiments need not be performed using the steps described above. Accordingly, the present embodiments are to be considered as illustrative and not restrictive, and the disclosed embodiments are not to be limited to the details given herein, but may be modified within the scope and equivalents of the appended claims.

What is claimed is:

1. A method, comprising:
identifying two or more network devices in a path between a first endpoint and a second endpoint;
obtaining a measurement of one or more metrics pertaining to functionality of the two or more network devices in the path between the first endpoint and the second endpoint; and
processing the one or more metrics pertaining to the functionality of the two or more network devices to generate a report pertaining to the path between the first endpoint and the second endpoint.

2. The method as recited in claim 1, further comprising:
analyzing the one or more metrics pertaining to the path between the first endpoint and the second endpoint.

3. The method as recited in claim 2, further comprising:
providing an indication of results of analyzing the one or more metrics pertaining to the path between the first endpoint and the second endpoint.

4. The method as recited in claim 2, further comprising:
providing one or more recommendations pertaining to the path between the first endpoint and the second endpoint.

5. The method as recited in claim 1, wherein the one or more metrics pertaining to the functionality of the two or more network devices comprises a measurement of recovery time due to failure of a software application running on each of the two or more network devices.

6. The method as recited in claim 1, wherein the one or more metrics pertaining to the functionality of the two or more network devices comprises a measurement of recovery time due to a failure of a routing protocol running on each of the two or more network devices.

7. The method as recited in claim 1, wherein the one or more metrics pertaining to the functionality of the two or more network devices comprise a measurement of recovery time due to a failure of at least one interface of each of the two or more network devices.

8. The method as recited in claim 1, wherein the one or more metrics pertaining to the functionality of the two or more network devices comprises a measurement of recovery time due to failure of hardware of each of the two or more network devices.

9. The method as recited in claim 8, wherein the hardware of each of the two or more network devices includes one or more line cards.

10. The method as recited in claim 8, wherein the one or more metrics pertaining to the functionality of the two or more network devices comprises a measurement of time between a first failure of the hardware of one of the two or more network devices and a second failure of the hardware of the one of the two or more network devices.

11. The method as recited in claim 1, wherein the first endpoint and the second endpoint are in a single network.

12. The method as recited in claim 1, wherein the two or more network devices include the first endpoint and the second endpoint.

13. The method as recited in claim 1, further comprising:
storing the measurement of each of the metrics pertaining to functionality of each of the two or more network devices in a database in accordance with a type of the corresponding network device.

14. A method, comprising:
ascertaining a measurement of one or more metrics pertaining to functionality of a network device;
storing the measurement of the one or more metrics pertaining to the functionality of the network device; and
providing an indicator of the measurement of the one or more metrics pertaining to the functionality of the network device.

15. The method as recited in claim 14, further comprising:
analyzing the measurement of the one or more metrics pertaining to the functionality of the network device; and
providing one or more recommendations pertaining to the network device.

16. The method as recited in claim 14, wherein the one or more metrics pertaining to the functionality of the network device comprises a measurement of recovery time due to failure of hardware of the network device.

17. The method as recited in claim 14, wherein the one or more metrics pertaining to the functionality of the network device comprises a measurement of recovery time due to failure of software running on the network device.

18. The method as recited in claim 14, wherein providing the indicator of the measurement of the one or more metrics pertaining to the functionality of the network device comprises providing the indicator of the measurement of the one or more metrics pertaining to the functionality of the network device to another network device.

19. An apparatus, comprising:
a processor; and
a memory, at least one of the processor or the memory being adapted for:
identifying two or more network devices in a path between a first endpoint and a second endpoint;
obtaining a measurement of one or more metrics pertaining to functionality of the two or more network devices in the path between the first endpoint and the second endpoint; and
processing the one or more metrics pertaining to the functionality of the two or more network devices to generate one or more path metrics pertaining to the path between the first endpoint and the second endpoint.

20. The apparatus as recited in claim 19, at least one of the processor or the memory being further adapted for:
analyzing the one or more metrics pertaining to the path between the first endpoint and the second endpoint; and
providing an indication of results of analyzing the one or more metrics pertaining to the path between the first endpoint and the second endpoint.

21. The apparatus as recited in claim 19, at least one of the processor or the memory being further adapted for:
providing one or more recommendations pertaining to the path between the first endpoint and the second endpoint.

22. An apparatus, comprising:
means for identifying two or more network devices in a path between a first endpoint and a second endpoint;
means for obtaining a measurement of one or more metrics pertaining to functionality of the two or more network devices in the path between the first endpoint and the second endpoint; and
means for processing the one or more metrics pertaining to the functionality of the two or more network devices to generate one or more path metrics pertaining to the path between the first endpoint and the second endpoint.
